(19) United States
(12) Patent Application Publication
(10) Pub. No.: US 2007/0183950 A1
(43) Pub. Date: Aug. 9, 2007

(54) Method and apparatus for solar heating a leach solution

(76) Inventor: Richard P. Lane, De Pere, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/348,685

(22) Filed: Feb. 7, 2006

(51) Int. Cl. C22B 3/00; F25B 29/00; B01F 1/00

(52) U.S. Cl. 423/1; 423/658.5; 165/48.2

(57) ABSTRACT

A method and apparatus for solar heating a leach solution prior to its distribution over an ore heap. The apparatus includes a solar heating device that is positioned adjacent to the ore heap to elevate the temperature of the leach solution above ambient. The solar heater includes a transparent cover film attached to a flexible base material along the side edges of the base material. A flow of air is introduced between the cover film and the base material to create an open interior. A series of heat absorbing tubes each extend through the open interior and receive the supply of leach solution such that the leach solution is heated by solar energy within the heat absorbing tube.

### BACKGROUND OF THE INVENTION

The present invention generally relates to heap leach mining. More specifically, the present invention relates to a method and apparatus that solar heats the leach solution prior to the leach solution being distributed for percolation through an ore heap.

Copper is frequently recovered from extremely low grade ores and from mine wastes by a process known as heap leaching. The term “heap” as used in the art means a bed of low grade ore that has been suitably spread over a prepared surface or “pad”. A dilute sulfuric acid solution is percolated through the heap and the “pregnant” copper-bearing acid solution is collected after it has percolated through the heap. Typically, the pad on which the heap rests is formed from an impervious material, such as sheets of plastic film (polyethylene), asphalt and/or compacted clay. The heap is often times constructed on an incline such that the copper-bearing leach solution that has percolated through the heap is collected in a reservoir.

The heap of ore is normally piled onto each impervious pad to a depth of 10 to 30 feet after the ore has been pre-crushed to a sufficiently small size to enable the leach solution to reach the metallic-mineral particles contained in the ore. It is a characteristic of heap leach mining that the maximum amount of copper can be recovered from the ore over a long period of time, typically measured in months and years. For example, a typical heap leach operation may reach a maximum copper recovery in a period of two to three years.

After the leach solution has passed through the ore heap, the copper-bearing leach solution is subjected to a solvent extraction process in which the copper is transformed from dilute leach solution into a pure and concentrated solution termed advance electrolyte. After the extraction, the advance electrolyte is subjected to an electro-winning process in which the dissolved copper plates out onto permanent stainless steel plates or pure thin copper sheets used as cathodes. The plated copper on each of the stainless steel cathodes can be removed and processed. The copper sheets, when used, grow in weight and can be processed as required.

Conventional percolation systems for heap leach mining normally include a series of individually spaced emitter tubes extending over the heap of ore. Each of the spaced tubes receives the leach solution and includes a series of openings to permit the leach solution to be distributed for uniform percolation down through the heap. An example of such a system is shown in the Krauth U.S. Pat. No. 5,030,279. In this type of system, each of the individual tubes are laid out over the ore heap in the desired spaced relationship such that the leach solution adequately permeates through the ore heap.

In heap leach operations, it has been found that metal recoveries are considerably lower in the winter season due to lower temperatures of the ore and the leach solution. Heap leach operations, utilizing both chemical and biological leach solutions, tend to operate most efficiently at temperatures above ambient. While others have proposed heating the leach solution at a location remote from the heap, heating the leach solution at such a remote location has proven to be very inefficient due to the substantial amount of heat lost to atmosphere as the leach solution is distributed to the tubing placed on the heap.

An example of a type of heaping and distributing system proposed to solve such problems is shown in the Lane U.S. Pat. No. 6,149,711. In the Lane '711 patent, a distribution mat having a series of individual emitter tubes connected to each other by heat absorbing panels is disclosed. The distribution mat is laid out over the heap and the temperature of the leach solution passing through the emitter tubes is elevated above ambient prior to the leach solution circulating down through the ore heap through openings formed in the emitter tubes of the mat. Although this type of system has proven to be an effective way to increase the temperature of the leach solution prior to the distribution over the ore heap, the pores formed in the emitter tubes create a problem in forming the mat and substantially increase the cost of the mat.

Another example of a heaping and distributing system proposed to solve such problems is shown in the Lane U.S. Pat. No. 6,743,276. In the Lane '276 patent, an integrated heating tube and mat assembly is applied over the array of emitter tubes positioned on the surface of the ore heap to solar heat the leach solution immediately prior to the leach solution being transferred to the array of drip lines or emitter tubes. Although this type of system has proven to be an effective way to increase the temperature of the leach solution prior to the distribution over the ore heap, the apparatus must be placed over the array of emitter tubes, thus posing a problem if the emitter tubes need to be moved.

Therefore, it is an object of the present invention to provide a method of increasing the rate at which a semi-precious metal can be extracted from an ore heap. It is a further object of the invention to provide a method that solar heats the leach solution prior to the leach solution being distributed over the bed of ore. It is an additional object of the invention to provide a method that solar heats the leach solution at a location adjacent to or near the ore heap and prior to the leach solution being percolated through the ore heap. It is a further object of the invention to provide an apparatus that solar heats the leach solution immediately prior to its percolation through the ore heap and at a location somewhat remote from the ore heap itself.

### SUMMARY OF THE INVENTION

The present invention is a method and apparatus for heating a leach solution prior to the leach solution being percolated through an ore heap. The apparatus is a solar heating device that can be positioned adjacent to or near the ore heap and operates to solar heat the leach solution to a temperature above ambient immediately prior to the leach solution being distributed through the series of spaced emitter tubes.

The solar heating device includes a continuous length of a flexible base material that extends between a first end and a second end and has first and second side edges. Preferably, the continuous length of flexible base material is formed from rubber and has a dark color, preferably black. The dark color of the base material aids in the absorption of solar energy.

The solar heater further includes a continuous length of a transparent cover material that is secured to the base material along the first and second edges of the base material. Preferably, the transparent cover material has a width slightly greater than the width of the base material such that the transparent cover material can be raised above the base material to define an open interior. In a preferred embodiment of the invention, an airflow generator is positioned to provide a flow of air between the transparent cover film and the base material such that the cover film is suspended above the base material by the flow of air. The suspension of the transparent cover film above the base material creates a greenhouse effect within the solar heater to further enhance the solar heating capabilities of the device. Preferably, the airflow generator is an electric fan coupled to a photovoltaic panel such that the fan is solar powered.

The solar heater further includes a series of heat absorbing tubes that each extend through the open interior of the solar heater from the first end of the solar heater to the second end of the solar heater. The heat absorbing tubes each receive a portion of the flow of the leach solution such that the leach solution passes through the series of heat absorbing tubes. Since the heat absorbing tubes pass through the open interior of the solar heater, the leach solution contained within the heat absorbing tubes absorb solar energy, which raises the temperature of the leach solution above ambient.

After the leach solution has been solar heated within the series of heat absorbing tubes, the leach solution is collected in a collection tube and distributed to the series of emitter tubes positioned on the ore heap. Once the heated leach solution is received in the emitter tubes, the emitter tubes allow the heated leach solution to percolate through the ore heap, thus enhancing the mining operation.

Various other features, objects and advantages of the invention will be made apparent from the following description taken together with the drawings.

### BRIEF DESCRIPTION OF THE DRAWINGS

The drawings illustrate the best mode presently contemplated in carrying out the invention.

In the drawings:

FIG. 1 is a top plan view of a heap leach mine utilizing the solar heater of the present invention to heat the mining leach solution prior to the leach solution being distributed over the ore heap;

FIG. 2 is a magnified view of the solar heater; and

FIG. 3 is a section view taken along line 3-3 of FIG. 2 illustrating the internal configuration of the solar heater.

### DETAILED DESCRIPTION OF THE INVENTION

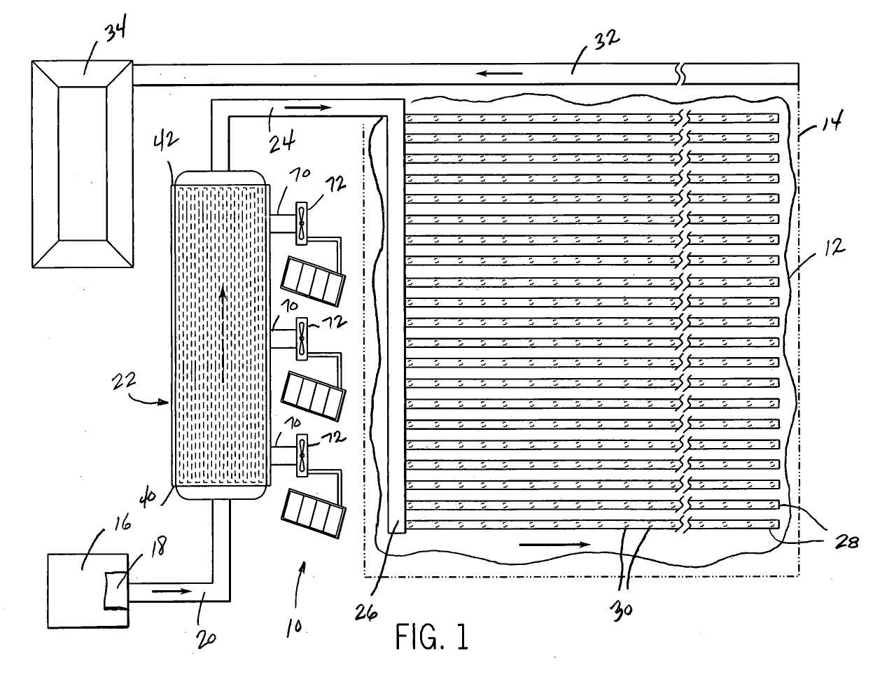

FIG. 1 illustrates a heap leach mining system 10 as positioned on a bed or heap 12 of low grade ore. The heap of ore 12 is comprised of pre-crushed ore of significantly small size that has a typical depth of between ten and thirty feet. The ore contained within the heap 12 contains small concentrations of a metal to be collected, such as low grade gold, silver or copper. In the embodiment of the invention to be described, the ore includes trace amounts of copper, although the invention is equally applicable to ores containing other desirable metals. The ore heap 12 is deposited on a pad 14 formed from an impervious material, such as sheets of plastic foam, asphalt and/or compacted clay. The pad 14 prevents the leach solution from entering into the ground and being absorbed, thereby reducing contamination to the ground.

As shown in FIG. 1, a supply of leach solution used to remove the desired material from the heap of ore 12 is drawn from a reservoir 16 by a pump 18 and a supply pipe 20. The supply pipe 20 feeds the supply of leach solution into a solar heater 22 that elevates the temperature of the leach solution above ambient. The details of the solar heater 22 will be described in greater detail below.

The leach solution exits the solar heater and is received within a collection pipe 24. The collection pipe 24 is in fluid communication with a distributing tube 26 that extends along the length of the ore heap 12. In many mining operations, the ore heap 12 can extend for hundreds of feet depending upon the size of the mining operation.

As illustrated in FIG. 1, the distributing tube 26 is coupled to a series of spaced emitter tubes 28 that each extend across the length of the ore heap 12. Each of the emitter tubes 28 includes a series of spaced emitter openings 30 that allow the leach solution flowing within the emitter tubes to be distributed onto the top of the ore heap. The use of emitter tubes to distribute a leach solution over an ore heap is well known and has been used for many years in the leaching of iron ore.

In the preferred embodiment of the invention, the ore heap 12 is constructed on an incline, such that the leach solution percolated through the ore heap 12 is directed by gravity to the lower edge of the pad 14, where the metal-bearing leach solution is collected in a collection trough 32. The collection trough 32, in turn, feeds the pregnant leach solution to a collection reservoir 34. The supply of pregnant leach solution from the collection reservoir 34 is then subject to a solvent extraction and electro-winning process in which the metallic material suspended in the pregnant leach solution is extracted from the leach solution in a conventional manner.

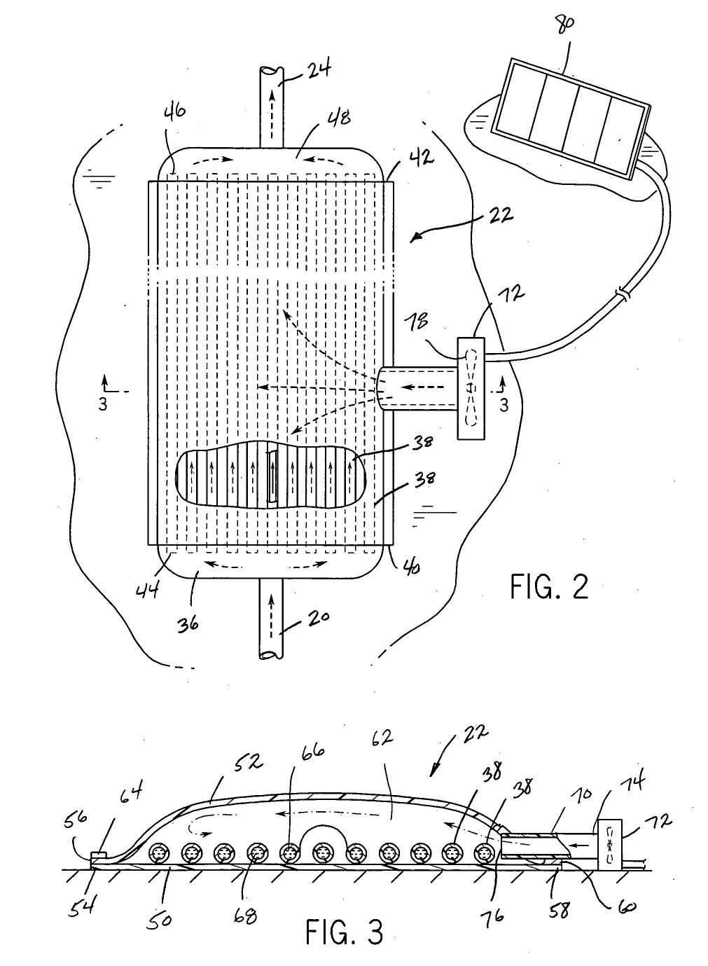

Referring now to FIG. 2, the supply of leach solution is delivered to the solar heater 22 by the supply pipe 20. The supply pipe 20 delivers the leach solution to a distribution manifold 36 that feeds the leach solution into a series of spaced heat absorbing tubes 38. Each of the heat absorbing tubes 38 extends from the first end 40 of the solar heater to a second end 48 of the solar heater 22. Specifically, the first end 44 of each heat absorbing tube 38 is in fluid communication with the distribution manifold 36, while a second end 46 of each heat absorbing tube 38 is in fluid communication with a collection manifold 48. The collection manifold 48 feeds the leach solution to the collection pipe 24 such that the leach solution can be distributed through the series of emitter tubes as previously described.

Referring now to FIG. 3, the solar heater 22 includes a flexible base material 50 and a transparent cover film 52. In the embodiment of the invention illustrated, the first edge 54 of the base material 50 is secured to the first edge 56 of the cover film 52, while the second edge 58 of the base material 50 is secured to the second edge 60 of the cover film 52. The edges of the base material 50 and the cover film 52 are secured to each other along the entire length of the solar heater 22 from the first end 40 to the second end 42, as can be understood in FIG. 2.

Referring back to FIG. 3, the overall width of the cover film 52 is greater than the width of the base material 50 such that the cover film 52 can be elevated above the base material 50 to create an open interior 62. In the preferred embodiment of the invention, the base material is formed from a flexible, rubber material preferably black in color. An example of the material used to form the base material 50 is the Cooley Coolpro RPP-7836TBPWIG4 having a thickness of 36 mils. The transparent cover film is preferably a sheet of transparent, plastic material such as DuPont Tefzel LZ having a 100 gauge thickness. However, it is contemplated that various other materials can be utilized while operating within the scope of the present invention.

As described above, the cover film 52 is secured to the base material 50 along the first and second edges of each component. In the embodiment of the invention illustrated, a section of tape material 64 is utilized. However, it is contemplated that the cover film 52 could be heat welded to the base material 50 or secured to the base material in any other conventional manner that restricts the flow of air between the cover film 52 and the base material 50 once the cover film is secured to the base material.

As illustrated in FIG. 3, the series of heat absorbing tubes 38 are supported on the base material 50 and spaced evenly throughout the open interior 62. Preferably, each of the heat absorbing tubes 38 is formed form a flexible rubber material, preferably black in color. The open interior 66 of each heat absorbing tube receives the leach solution 68 such that the leach solution can be heated within the solar heater 22. Since the cover film 52 is transparent, solar energy can be absorbed by both the base material 50 and the individual heat absorbing tubes 38 to elevate the temperature within the open interior 62. As the leach solution flows from the first end 40 to the second end 42 of the solar heater 22, the temperature of the leach solution is elevated above ambient. During a sunny day, the temperature of the leach solution can be elevated by approximately 5°-8° Fahrenheit above ambient during periods of full sun prior to the leach solution exiting into the collection pipe 24. An increase in temperature of 10 Fahrenheit allows up to 1% more metal to be recovered from the ore heap by the leach solution.

Referring back to FIG. 1, the solar heater 22 includes a series of airflow inlet tubes 70 spaced along the overall length of the solar heater from the first end 40 to the second end 42. Each of the inlet tubes 70 is in communication with an airflow generator 72 such that the airflow generator 72 can create a flow of air passing through the inlet tube 70 and into the open interior of the solar heater 22.

Referring now to FIGS. 2 and 3, each of the inlet tubes 70 includes a first end 74 coupled to the airflow generator 72 and a second end 76 that extends into the open interior 62. When the airflow generator 72 is operating, a flow of air enters into the open interior 62 from the second end 76 to create an internal pressure that separates the cover film 52 from the base material 50. The separation between the cover film 52 and the base material 50 creates a greenhouse-like environment within the solar heater 22. The flow of air allows the temperature within the open interior 62 to elevate and thus heat the leach solution passing through the series of spaced heat absorbing tubes 38.

In the preferred embodiment of the invention, the airflow generator 72 is a conventional electric fan having a rotating fan blade 78, as best shown in FIG. 2. The airflow generator is preferably coupled to a photovoltaic panel 80 such that the airflow generator can be solar powered. Since the solar heater 22 will most likely be utilized in a remote location that does not include a supply of electricity, the photovoltaic panel 80 is used to power the airflow generators 72. Other sources of electrical power, such as a wind turbine or battery, are also contemplated as being within the scope of the invention. Since the solar heater 22 will be effective only during periods of sunlight, the use of the photovoltaic panel 80 to power the airflow generator 72 allows the solar heater 22 to be operational during periods of sunlight.

In the embodiment of the invention illustrated in FIG. 2, each of the heat absorbing tubes 38 is coupled to the distribution manifold 36 such that the entire supply of the leach solution is received within the heat absorbing tubes. Likewise, the second end of each heat absorbing tube 46 feeds the heated leach solution into the collection manifold 48, which in turn is coupled to the collection pipe 24. As illustrated in FIG. 1, the solar heater 22 is preferably positioned adjacent to the ore heap 12 such that the solar heater 22 can be set up independently of the emitter tubes 28. Although a small portion of the heat within the leach solution may be lost during the flow of the leach solution within the collection pipe 24 and the distributing tube 26, it is believed that the amount of heat lost during this flow will be negligible relative to the temperature elevation of the leach solution within the solar heater 22.

As previously described, once the leach solution has been heated within the solar heater 22, the leach solution travels through the collection pipe 24 and into the distributing tube 26. The distributing tube 26 is connected to each of the series of spaced emitter tubes 28, as illustrated in FIG. 1. Once the heated leach solution is received within the emitter tubes 28, the leach solution follow through the emitter tubes and exists the plurality of openings 30 formed in each of the tubes 28. In accordance with the present invention, the leach solution is heated immediately prior to it entering the distributing tube 26 located on the ore heap 12.

After the leach solution has passed through the ore heap 12 and removes the desired metal material, the pregnant leach solution is collected on the impervious pad 14 and flows downward into the collection trough 32. Once in the collection trough 32, the copper-bearing leach solution flows into the collection reservoir 34. The pregnant leach solution in a conventional manner.

Various alternatives and embodiments are contemplated as being within the scope of the following claims.

I claim:

1. A method of heap leach mining to remove a metallic material from a heap of ore accumulated upon an impervious pad, the method comprising the steps of:
positioning a plurality of emitter tubes in a spaced relationship to each other on the ore heap, each emitter tube having a plurality of emitter openings;
providing a supply of leach solution;
drawing the supply of leach solution through a solar heater position near the ore heap to heat the leach solution above an ambient temperature;
transferring the heated leach solution from the solar heater into the plurality of emitter tubes;
emitting the solar-heated leach solution through the emitter opening such that the leach solution percolates through the heap of ore; and
collecting the leach solution from the impervious pad after the leach solution has percolated through the ore heap.

2. The method of claim 1 wherein the solar heater comprises:
a continuous length of a flexible base material having a first side edge and a second side edge;
a continuous length of a transparent cover film, wherein the transparent cover film is secured to the base material along the first and second edges of the base material to define an open interior between the cover film and the base material; and
a plurality of heat absorbing tubes each extending through the open interior from a first end of the solar heater to a second end of the solar heater,
wherein each of the heat absorbing tubes receives the supply of leach solution such that the leach solution is heated by solar energy as the leach solution passes through the heat absorbing tubes.

3. The method of claim 2 wherein the base material is black.

4. The method of claim 2 further comprising the step of providing a flow of air between the base material and the cover film to separate the cover film from the loose material.

5. The method of claim 4 wherein the flow of air is provided by an airflow generator.

6. The method of claim 5 further comprising the step of positioning the airflow generator at a first end of an air inlet tube having a second end extending between the base material and the cover film.

7. The method of claim 6 further comprising the step of connecting the airflow generator to a photovoltaic panel to provide power to the airflow generator.

8. A device for solar heating a supply of leach solution, the device comprising:
a continuous length of a flexible base material having a first side edge and a second side edge;
a continuous length of a transparent cover film, wherein the transparent cover film is secured to the base material along the first and second edges of the base material to define an open interior between the cover film and the base material; and
a plurality of heat absorbing tubes each extending through the open interior from a first end of the solar heater to a second end of the solar heater,
wherein each of the heat absorbing tubes receives the supply of leach solution such that the leach solution is heated by solar energy as the leach solution passes through the heat absorbing tubes.

9. The device of claim 8 wherein the base material is black.

10. The device of claim 8 further comprising an airflow generator operable to provide a flow of air between the base material and the cover film such that the cover film is spaced from the base material by the flow of air to define the open interior.

11. The device of claim 10 wherein the airflow generator is solar powered.

12. The device of claim 10 wherein the airflow generator is coupled to a first end of an inlet tube having a second end extending between the base material and the cover film such that the flow of air created by the airflow generator can pass between the base material and the cover film.

13. The device of claim 8 wherein the cover film is joined to the first and second side edges of the base material by an adhesive.

14. The device of claim 8 wherein a first end of each of the heat absorbing tubes is coupled to a supply pipe and a second end of each of the heat absorbing tubes is coupled to a collection pipe.

15. The device of claim 8 wherein each of the heat absorbing tubes is formed from a flexible rubber material.

16. A device for solar heating a supply of leach solution, the device comprising:
a continuous length of a flexible base material having a first side edge and a second side edge;
a continuous length of a transparent cover film, wherein the transparent cover film is secured to the base material along the first and second edges of the base material to define an open interior between the cover film and the base material;
an airflow generator operable to provide a flow of air between the base material and the cover film such that the cover film is spaced from the base material by the flow of air to define the open interior; and
a plurality of heat absorbing tubes each extending through the open interior from a first end of the solar heater to a second end of the solar heater,
wherein each of the heat absorbing tubes receives the supply of leach solution such that the leach solution is heated by solar energy as the leach solution passes through the heat absorbing tubes.

17. The device of claim 16 wherein the base material is black.

18. The device of claim 16 wherein the airflow generator is solar powered.

19. The device of claim 16 wherein the airflow generator is coupled to a first end of an inlet tube having a second end extending between the base material and the cover film.

20. The device of claim 16 wherein a first end of each of the heat absorbing tubes is coupled to a supply tube and a second end of each of the heat absorbing tubes is coupled to a collection tube.

21. The device of claim 16 wherein the width of the base material is less than the width of the cover film.
